(19) United States
(12) Patent Application Publication
(10) Pub. No.: US 2026/0267104 A1
(43) Pub. Date: Sep. 10, 2026

(54) Fiber Optic Enclosure with Improved Sealing System

(71) Applicant: Multilink Inc., Elyria, OH (US)

(72) Inventor: Steven E. Kaplan, Elyria, OH (US)

(73) Assignee: Multilink Inc., Elyria, OH (US)

(21) Appl. No.: 19/561,319

(22) Filed: Mar. 9, 2026

Related U.S. Application Data
(60) Provisional application No. 63/769,145, filed on Mar. 9, 2025.

(51) Int. Cl. G02B 6/44

(52) U.S. Cl. CPC G02B 6/4444; G02B 6/4454

(57) ABSTRACT

A fiber enclosure includes a base and a dome. A fiber optic splice tray support structure is located in the dome. A gel seal insert is located in the base and includes a gel seal element between first and second compression plates. The gel seal insert includes an actuator that is selectively actuatable to compress the gel seal element between the compression plates. The gel seal element includes cable ports for passage of fiber optic cables through the base and into the internal space of the dome. First and second guide pins are connected to one of the first and second compression plates and extend into corresponding first and second guide pin apertures defined through the other of the first and second compression plates such that the first and second guide pins project outwardly through the first and second guide pin apertures when the compression plates are drawn together.

### CROSS-REFERENCE TO RELATED APPLICATION

This application claims priority from and benefit of the filing date of U.S. provisional application Ser. No. 63/769,145 filed Mar. 9, 2025, and the entire disclosure of said provisional application is hereby expressly incorporated by reference into the present application.

### BACKGROUND

Fiber enclosures for containing and protecting fiber optic cables, splices and related components are generally well-known and in widespread use. Known enclosures utilize a wide variety of seals that form an environmental seal around each cable that passes into and out of the enclosure to prevent ingress of water and other contaminates. A need has been identified for such an enclosure that includes a new and improved sealing system.

### SUMMARY

In accordance with one aspect of the present development, a fiber enclosure includes a lower portion including a base and an upper portion including a dome that is selectively secured to the base. A fiber optic splice tray support structure is located in an internal space of the dome. A gel seal insert is located in the base and includes a gel seal element located between first and second compression plates. The gel seal insert includes an actuator that is accessible outside the base and selectively rotatable or otherwise actuatable compress the gel seal element between the first and second compression plates, the gel seal element including a plurality of cable ports for passage of fiber optic cables through the base and into the internal space of the dome, wherein said gel seal element inhibits ingress of water and/or other environmental contaminants into the internal space of the dome between the cables and the gel seal element. First and second guide pins are connected to one of the first and second compression plates and extend through the gel seal element and into corresponding first and second guide pin apertures defined in the other of the first and second compression plates such that the first and second guide pins project outwardly through the first and second guide pin apertures, respectively, when the first and second compression plates are drawn together.

In one example, the dome is secured to the base in its operative position using a dome clamp.

In accordance with another aspect of the present development, the magnitude by which the first and second guide pins project outwardly through the first and second guide pin apertures, respectively, provides a visual indication of an amount of compression of the gel seal insert between the first and second compression plates.

In accordance with another aspect of the present development, the fiber enclosure, further comprises a support plate connected to an inner end of the base, wherein the support plate providing a mounting location for the fiber optic splice tray.

In accordance with a further aspect of the present development, the support plate includes a plurality of cable mounting recesses that are circumferentially spaced about the support plate.

In accordance with another aspect of the present development, each of the cable mounting recesses includes an open outer end that opens through a periphery of the support plate and a closed inner end such that each of the cable mounting recesses is U-shaped.

In accordance with still another aspect of the present development, the fiber enclosure further includes a plurality of clips that are engaged with the support plate, wherein each of said clips is connected adjacent and aligned with a respective one of said cable mounting recesses; and first and second bracket slots are defined between each clip and the support plate on opposite lateral sides of the respective one of the cable mounting recesses.

In accordance with a further aspect of the present development, the fiber enclosure further includes a plurality of strain relief brackets respectively connected to associated fiber optic cables and each engaged with the support plate adjacent a respective one of the plurality of cable mounting recesses.

In accordance with still a further aspect of the present development, each of the plurality of strain relief brackets comprises: (i) a strain relief clamp adapted to be secured to a strength member of one of the associated fiber optic cables; and (ii) first and second flanges that are respectively slidably engaged with the first and second bracket slots of the respective one of the said plurality of cable mounting recesses.

In accordance with another aspect of the present development, the first and second compression plates each comprise a periphery and a plurality of cable pass-through recesses; the first and second compression plates are aligned with each other so that the plurality of cable pass-through recesses are respectively registered with each other as between the first and second compression plates; and, the plurality of cable pass-through recesses are each aligned with a respective one of the plurality of cable ports of the gel seal element.

In accordance with another aspect of the present development, the cable pass-through recesses of each of the first and second compression plates are normally closed by a removable web that can be selectively broken away to open the cable pass-through recess through the periphery.

In accordance with still another aspect of the present development, the first and second compression plates each include a plurality of circumferentially spaced-apart axial tabs that extend axially inward toward the gel seal element and that are received in corresponding respective notches defined in the gel seal element.

In accordance with a further aspect of the present development, the gel seal element includes a center core portion that is generally disc shaped and an outer annular ring portion that surrounds the center core portion and that includes an axial split to allow the outer annular ring portion to be installed around the center core portion.

In accordance with still a further aspect of the present development, the plurality of cable ports are partially defined in an outer peripheral surface of the center core portion and partially defined in the inner peripheral surface of the outer ring portion.

In accordance with another aspect of the present development, the center core portion is radially split into a first center core portion and a second center core portion, wherein the first and second center core portions include respective inner core faces that are abutted with each other and include respective outer core faces that are oriented outwardly away from each other, wherein the respective inner core faces are softer than the respective outer core faces.

In accordance with another aspect of the present development, the outer ring portion is radially split into a first ring portion and a second ring portion, wherein said first and second ring portions include respective inner ring faces and respective outer ring faces, and wherein the respective inner ring faces are abutted with each other and are relatively softer than the respective outer ring faces.

In accordance with still another aspect of the present development, the notches are defined in the outer ring faces of the gel seal element.

In accordance with a further aspect of the present development, a fiber enclosure includes a lower portion including a base and an upper portion including a dome that is selectively secured to the base. A fiber optic splice tray support structure is located in an internal space of the dome. A gel seal insert is located in the base and includes a gel seal element located between first and second compression plates. The gel seal insert includes an actuator that is accessible outside the base and selectively rotatable or otherwise actuatable compress the gel seal element between the first and second compression plates, the gel seal element including a plurality of cable ports for passage of fiber optic cables through the base and into the internal space of the dome, wherein said gel seal element inhibits ingress of water and/or other environmental contaminants into the internal space of the dome between the cables and the gel seal element. First and second compression plates each include a periphery and a plurality of cable pass-through recesses. The first and second compression plates are aligned with each other so that the plurality of cable pass-through recesses are respectively registered with each other as between the first and second compression plates. The plurality of cable pass-through recesses are each aligned with a respective one of the plurality of cable ports of the gel seal element. The cable pass-through recesses of each of the first and second compression plates are normally closed by a removable web that can be selectively broken away to open the cable pass-through recess through the periphery. The first and second compression plates can each include a plurality of circumferentially spaced-apart axial tabs that extend axially inward toward the gel seal element and that are received in corresponding respective notches defined in the gel seal element.

### BRIEF DESCRIPTION OF THE DRAWINGS

FIG. 1 is an isometric view that illustrates a fiber enclosure provided in accordance with an embodiment of the present development.

FIG. 2 is a partial exploded view of the enclosure of FIG. 1.

FIG. 3 is an isometric view of a lower portion of the enclosure of FIG. 1.

FIG. 4 is similar to FIG. 3 but is partially exploded to reveal additional details of the lower portion;

FIG. 5 is a top plan view of the lower portion of FIG. 3.

FIG. 6 is a bottom isometric view of the lower portion of FIG. 3.

FIG. 7 is a partial section view of the lower portion s taken at cutting plane 7-7 of FIG. 5.

FIG. 8 is an isometric view of the gel seal insert.

FIG. 9 provides an exploded isometric view of the gel seal insert of FIG. 8.

FIG. 10 is an isometric view of the gel seal element of the gel seal insert showing an associated fiber optic cable passing there through.

### DETAILED DESCRIPTION

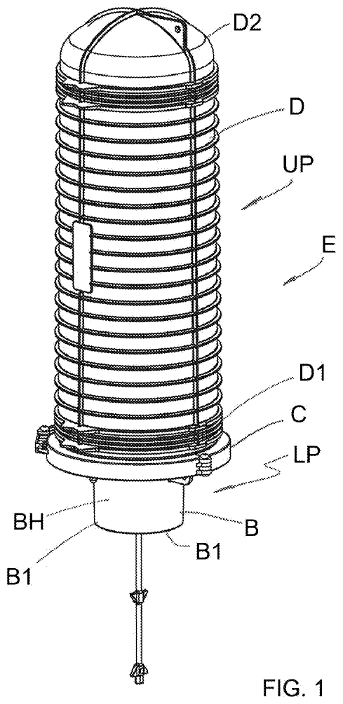

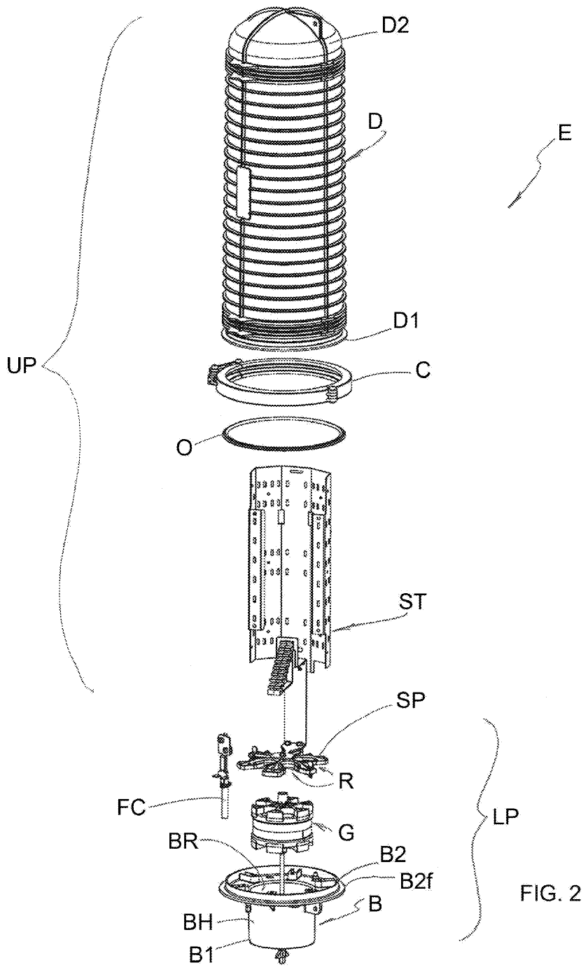

FIG. 1 is an isometric view that illustrates a fiber enclosure E provided in accordance with an embodiment of the present development. The enclosure E comprises a lower portion LP including a cylindrical, annular base B and an upper portion UP including a dome cover or dome D that is selectively secured to the base B using a dome clamp C that releasably secures the dome D in its operative position relative to the base as shown in FIG. 1. An elongated seal compression actuator T extends axially away from a first (outer) end B1 of the base B outside the base B and is selectively manually rotated or otherwise actuatable by a user in a first direction to compress a gel seal insert G (FIG. 2) located in the base B and in a second opposite direction to allow the gel seal insert to release the compressive force on the gel seal insert G. The base B also includes a second (inner) end B2 that is opposite the first (outer) end B1.

Referring also to the exploded view of FIG. 2, the dome D is open at an inner end D1 and closed at an opposite outer end D2. The open inner end D1 of the dome D is abutted and mated with the second end B2 of the base B. The dome D defines an internal space in which a known fiber optic splice tray support structure ST and related fiber optic cable connection and support elements are received. In particular, the open end D1 of the dome is selectively axially engageable with a mounting flange B2f located adjacent the base second end B2 and that extends radially outward from and circumferentially around the second end B2 of the base B. The clamp C is selectively engaged with both the flange B2f and the inner end D1 of the dome D to releasably operably secure the dome D to the base B. An O-ring or similar gasket O can be provided adjacent the flange B2f between the base B and the dome D to provide an environmental seal between these components.

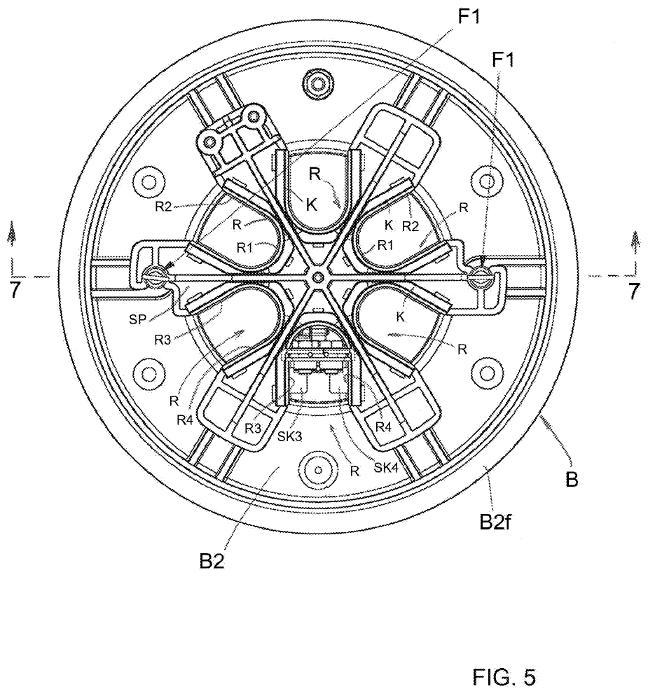

Referring also to FIG. 2-6, a support plate SP is connected to the second (inner) end B2 of the base B such as by support plate fasteners F1 and provides a mounting location for the splice tray support structure ST and for securing associated fiber optics cables FC that enter and exit the enclosure E. As described in further detail below, the support plate SP includes a plurality of cable mounting recesses R that are spaced circumferentially about the center of the support plate SP and each of which opens through a periphery of the support plate SP such that each cable mounting recess R includes a closed inner end R1 and an open outer end R2 (see FIG. 5) and is generally U-shaped.

As best seen in FIGS. 2, 6, and 7, the annular base B comprises a cylindrical tubular seal housing portion BH that defines an internal cylindrical bore BR that includes open first and second opposite ends BR1,BR2 that open respectively through the first and second opposite ends B1,B2 of the base B. A gel seal insert G is closely slidably received through the open second (inner) end BR2 of the cylindrical bore BR. The opposite first (outer) end BR1 of the bore BR is partially obstructed to capture the gel seal insert G in the bore BR and prevent axially movement and exit of the gel seal insert G out of the open first (outer) end BR1 of the bore BR. In the illustrated example, the base B comprises an inner radial flange B1f located adjacent the first end B1 of the base B and that extends radially inward from and circumferentially around the tubular seal housing portion BH adjacent the first (outer) end B1 of the base B into the bore BR to reduce the diameter of the bore BR sufficiently to capture the gel seal insert G in the bore BR and prevent exit of the gel seal insert G via open first end BR1 of the bore BR. The gel seal insert actuator T extends outwardly away from the gel seal insert G through the open first end BR1 of the bore BR.

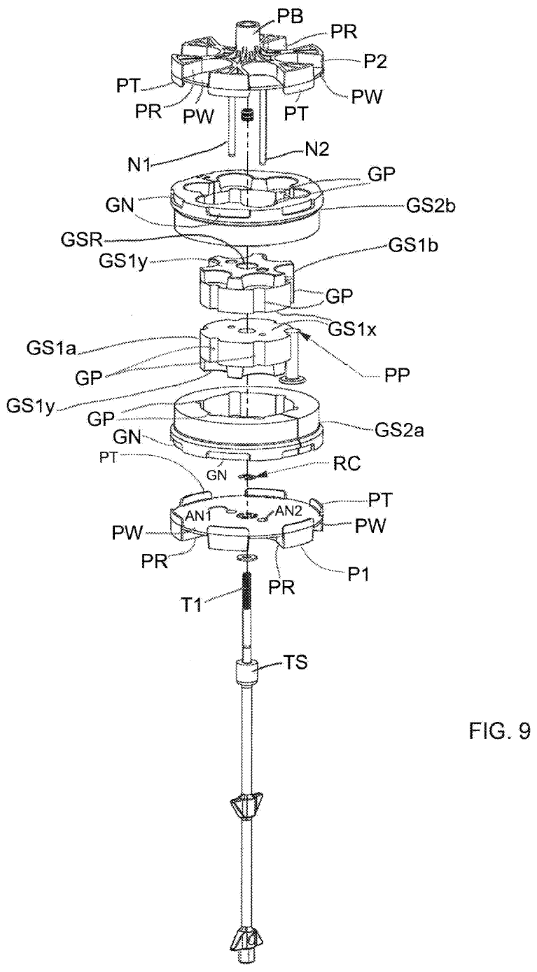

One or more associated fiber optic cables FC (see FIGS. 2 & 4) are received into the enclosure E and exit the enclosure E by passing through the open first end BR1 of the bore BR at the first end B1 of the base. The cable(s) FC pass through the gel seal insert G which seals about the cable(s) FC and prevents ingress of water and other environmental contaminants into the enclosure E along the cable(s) FC such that the cables FC can be spliced and/or otherwise connected inside the enclosure E and be protected from the external environment. More particularly, a cable FC enters the enclosure E through the open first end BR1 of the base B and passes through a port GP (FIGS. 9 & 10) defined in the gel seal insert G. A cable FC can exit the enclosure E in an opposite fashion by passing through a port GP defined in the gel seal insert G and then exit the enclosure E through the open first end BR1 of the bore BR.

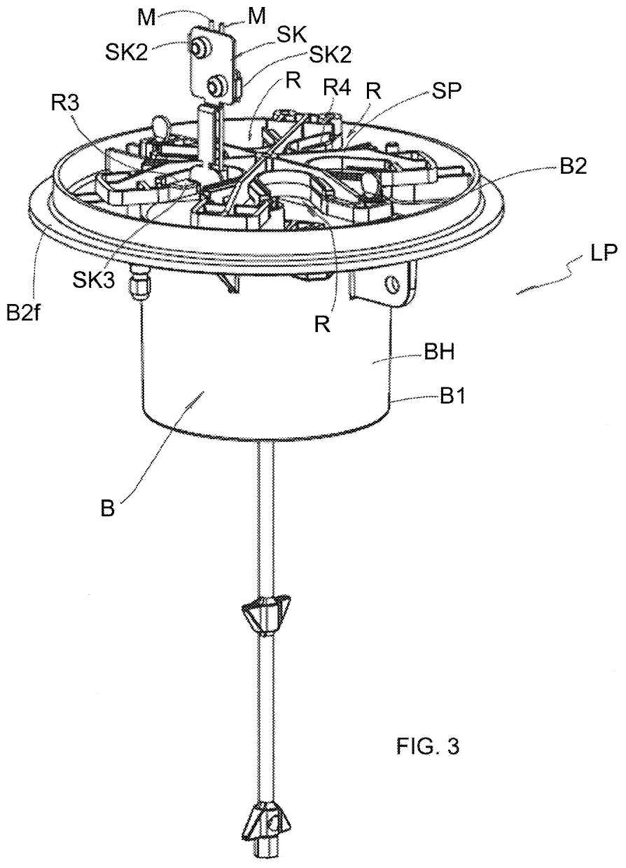

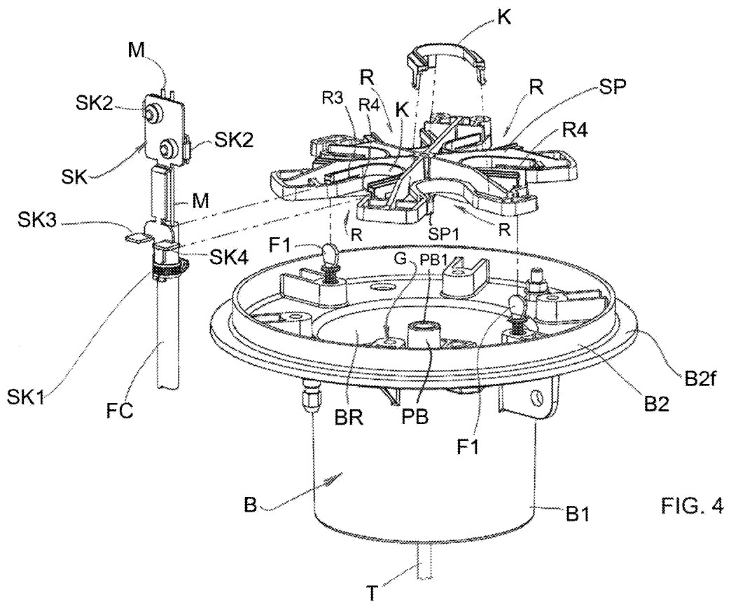

As shown in FIGS. 3 & 4, each cable FC is axially secured in the enclosure to provide strain relief by a strain relief bracket SK that is fastened to the cable FC (such as by a hose clamp SK1 or the like) and that includes one or more strain relief clamps SK2 that are selectively engaged with and axially secured to respective strength members M of the cable FC. The strain relief bracket SK includes first and second flanges SK3,SK4 that are respectively slidably engaged with first and second bracket slots R3,R4 of each recess R of the support plate SP (see also FIG. 5). In the illustrated example, the support plate SP includes a plurality of clips K that are snapped, friction fit, glued, or otherwise engaged with the support plate SP, with each clip K being U-shaped so as to correspond in shape to the recesses R of the support plate and each clip K connected adjacent and in registration or alignment with a recess R with a small space between the clip K and support plate SP such that the bracket slots R3,R4 are defined between the clip K and the support plate SP on opposite lateral sides of the recess R. As shown in FIG. 4, the first and second flanges SK3,SK4 of each strain relief bracket SK can be slid into the respective bracket slots R3,R4 such that the strain relief bracket SK and the cable FC secured thereto are axially fixed to the support plate SP and are prevented from moving into and/or out of the enclosure E relative to the support plate SP along the longitudinal axis of the cable FC.

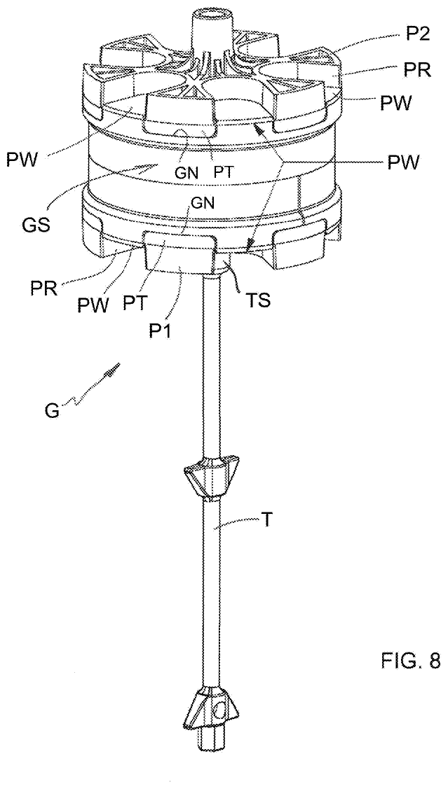

The gel seal insert G is shown separately in FIGS. 8 and 9 and comprises a gel seal element GS that includes a center core portion GS1 that is generally circular or disc shaped and an outer annular ring portion GS2 that surrounds the center core portion GS1. The outer annular ring portion GS2 includes an axial split to allow it to be installed around the center core portion GS1. The cable ports GP are partially defined in an outer peripheral surface of the center core portion GS1 and partially defined in the inner peripheral surface of the outer ring portion GS2. As shown in FIGS. 9 & 10, any unused ports GP in the gel seal element GS can be filled with a removable plug PP.

In the illustrated example, the center core portion GS1 is radially split into first (lower) and second (upper) identical or substantially similar center core portions GS1a, GS1b that each include an inner core face GS1x and an outer core face GS1y, wherein the inner core faces GS1x are abutted with each other and are relatively softer than the outer core faces GS1y which are oriented outwardly away from each other. Similarly, in the illustrated example, the outer ring portion GS2 is radially split into first (lower) and second (upper) identical or substantially similar annular ring portions GS2a, GS2b that each include an inner ring face GS2x and an outer ring face GS2y, wherein the inner ring faces GS2x are abutted with each other and are relatively softer than the outer ring faces GS2y which are oriented outwardly away from each other.

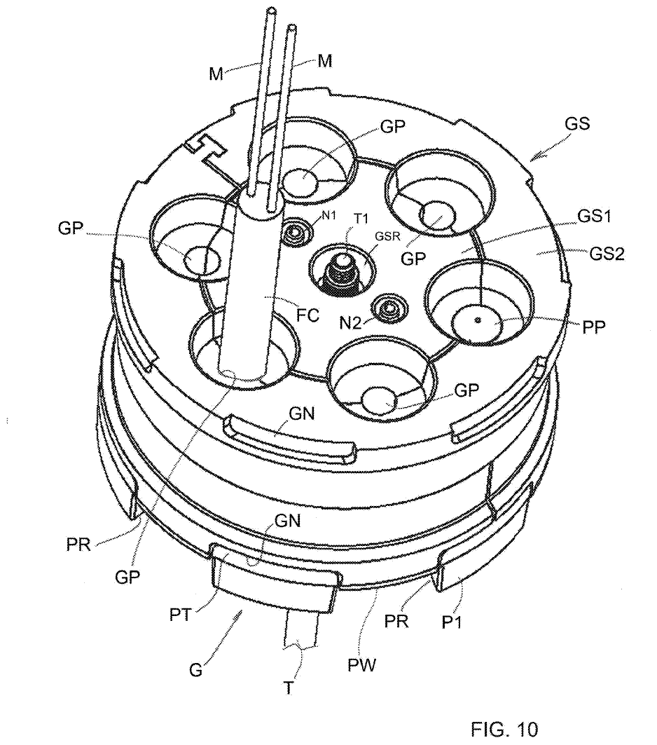

The gel seal element GS is contained between a first (outer) and a second (inner) compression plates P1,P2 that are each generally circular in shape but that each include a plurality of cable pass-through recesses PR that are generally U-shaped and that open through the outer periphery of the plate P1,P2 (see also FIG. 10 where the second (inner) pressure plate is removed). These cable pass-through recesses PR are each aligned with a cable port GP defined in the gel seal element GS. The cable pass-through recesses PR are normally closed or blocked by a removable web PW that can be selectively broken away or otherwise manually removed from the compression plate P1,P2 to open the respective cable pass-through recess PR as needed for a cable to pass there through. The first and second compression plates P1,P2 are generally aligned with each other so that the cable pass-through recesses PR are aligned or registered as between the two compression plates P1,P2 to allow the passage of fiber cable FC. The first and second compression plates P1,P2 are also generally aligned with the gel seal element GS so that the cable pass-through recesses PR are each aligned or registered with a respective cable port GP of the gel seal element GS. To facilitate this alignment between the compression pates P1,P2 and the gel seal element GS, the compression plates P1,P2 include a plurality of circumferentially spaced-apart axial tabs PT that extend axially inward toward the gel seal element GS and that are received in corresponding respective notches GN defined in the outer faces GS2y of the first and second annular ring portions GS2a, GS2b. The compression plate tabs PT also serve to radially contain the gel seal element GS.

The seal compression actuator T includes a threaded inner end T1 that passes through a central aperture of the first (outer) compression plate P1 and that is threadably engaged with a central plate boss PB of the second (inner) compression plate P2. The actuator T also passes through a central axial bore GSR of the gel seal element GS. The first (outer) compression plate P1 is axially captured on the actuator T between a radially enlarged shoulder TS and a retaining element such as a clip RC so that the first compression plate P1 can rotate relative to the actuator T but cannot slide axially on the actuator T. As such, rotation of the seal compression actuator T in a first direction draws the second compression plate P2 toward the first compression plate P1 and compresses the gel seal element GS between the plates P1,P2 so that the gel seal element GS seals about the fiber cables FC located in the ports GP, while rotation of the seal compression actuator T in an opposite second direction moves the second plate P2 away from the first plate P1 to allow the seal element GS to decompress.

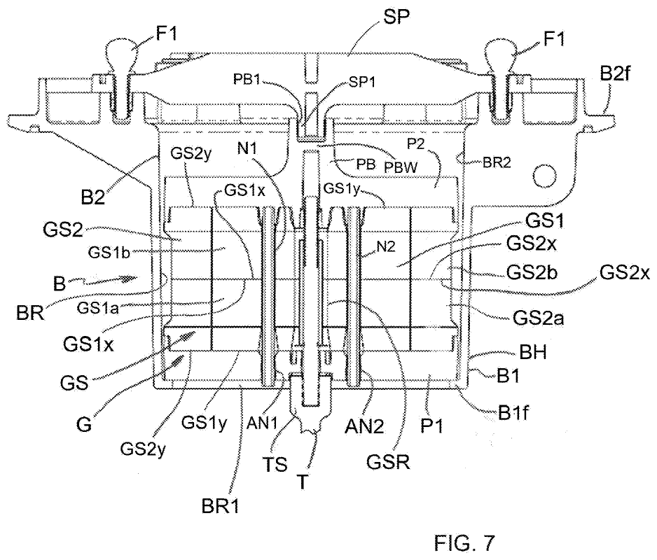

With particular reference to FIGS. 4 & 7, the central plate boss PB of the second (inner) compression plate P2 projects outwardly from an exposed face of the second compression plate P2 away from the gel seal element GS an includes a recess PB1 that is adapted to receive a stem SP1 of the support plate SP to facilitate locating and installing the support plate SP. The central plate boss PB includes an internal wall or web PBW (FIG. 7) that blocks water or other fluid flow through the central plate boss PB from the gel seal element central bore GSR to ensure that any liquid that flows into the gel seal element bore GSR and from there into the central plate boss PB cannot exit the central plate boss PB and flow into the area of the support plate SP and splice tray ST.

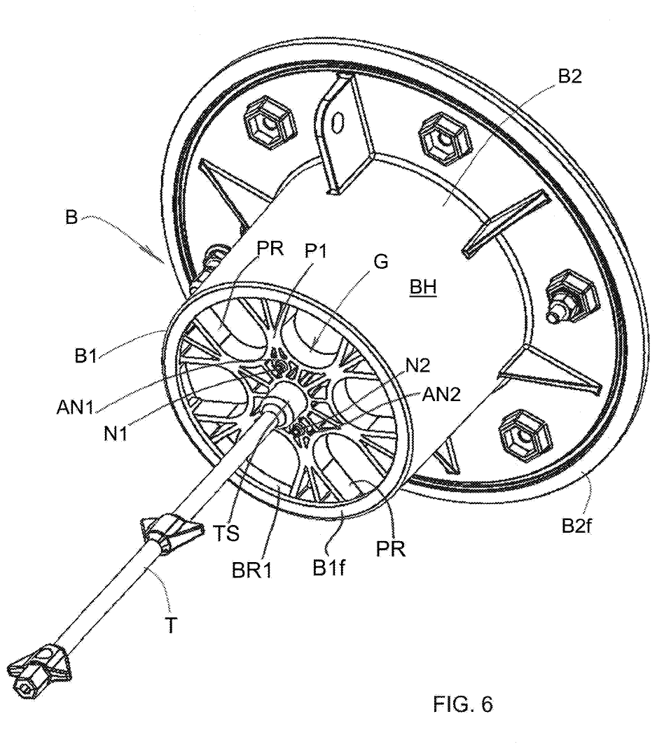

To further stabilize the gel seal element GS and ensure its proper location and alignment between the compression plates P1,P2, the gel seal insert G further comprises first and second parallel, spaced-apart guide pins N1,N2 that are connected to the second (inner) compression plate P2 to move axially therewith and that extend axially through the center core portion GS1 of the gel seal element GS parallel to the actuator T and that extend into respective guide pin apertures AN1,AN2 defined in and that extend completely through the first (outer) compression plate P1. In the illustrated example, the guide pins N1,N2 extend through both the first (lower) and second (upper) center core portions GS1a, GS1b of the gel seal element GS. The guide pins N1,N2 help to radially contain the gel seal element GS (in particular the center core portion GS1) and also inhibit rotation of the gel seal element GS about the actuator T (in particular the center core portion GS1) when the compression plates P1,P2 are drawn together to compress the gel seal element GS. When the compression plates P1,P2 are drawn together, the first and second guide pins N1,N2 move axially with the second (inner) compression plate P2 and extend outwardly through the respective guide pin apertures AN1,AN2 (see also FIG. 6), and the projecting outer ends of the guide pins N1,N2 provide an operator with a visual indication of the distance by which the second (inner) compression plate P2 is moved axially toward the first (outer) compression plate to compress of the gel seal element GS, i.e., the distance by which the ends of the guide pins N1,N2 project through and outwardly away from the first (outer) compression plate P1 provides a visual indication to an operator of the magnitude of compression of the gel seal element GS between the compression plates P1,P2. Alternatively, either one or both of the guide pins N1,N2 can be connected to and axially fixed relative to the first (outer) compression plate P1 and the corresponding guide pin aperture(s) AN1,AN2 can be located in and extend through the second (inner) compression plate P2 such that the guide pins N1,N2 project into the apertures AN1,AN2 and outwardly through the second (inner) compression plate P2 when the first and second compression plates P1,P2 are drawn together to compress the gel seal element GS.

The development has been described with reference to preferred embodiments. Modifications and alterations will occur to those of ordinary skill in the art to which the invention pertains, and it is intended that the claims be construed as broadly as possible while maintaining their validity in order to encompass all such modifications and alterations.

1. A fiber enclosure comprising:
a lower portion including a base and an upper portion including a dome that is selectively secured to the base;
a fiber optic splice tray support structure located in an internal space of the dome;
a gel seal insert located in the base and including a gel seal element located between first and second compression plates, said gel seal insert including an actuator that is accessible outside the base and selectively actuatable to compress the gel seal element between the first and second compression plates, the gel seal element including a plurality of cable ports for passage of fiber optic cables through the base and into the internal space of the dome, wherein said gel seal element inhibits ingress of water and/or other environmental contaminants into the internal space of the dome between the cables and the gel seal element;
first and second guide pins that are connected to one of the first and second compression plates and that extend through the gel seal element and into corresponding first and second guide pin apertures defined in the other of the first and second compression plates such that the first and second guide pins project outwardly through the first and second guide pin apertures, respectively, when the first and second compression plates are drawn together.

2. The fiber enclosure as set forth in claim 1, wherein a magnitude by which the first and second guide pins project respectively outwardly through the first and second guide pin apertures provides a visual indication of an amount of compression of the gel seal insert between the first and second compression plates.

3. The fiber enclosure as set forth in claim 1, further comprising:
a support plate connected to an inner end of the base, said support plate providing a mounting location for said fiber optic splice tray.

4. The fiber enclosure as set forth in claim 3, wherein said support plate comprises a plurality of cable mounting recesses that are circumferentially spaced about the support plate.

5. The fiber enclosure as set forth in claim 4, wherein each of said cable mounting recesses includes an open outer end that opens through a periphery of the support plate and a closed inner end such that each of said cable mounting recesses is U-shaped.

6. The fiber enclosure as set forth in claim 5, further comprising a plurality of clips that are engaged with the support plate, wherein:
each of said clips is connected adjacent and aligned with a respective one of said cable mounting recesses; and
first and second bracket slots are defined between each clip and the support plate on opposite lateral sides of the respective one of the cable mounting recesses.

7. The fiber enclosure as set forth in claim 6, further comprising a plurality of strain relief brackets respectively connected to associated fiber optic cables and each engaged with said support plate adjacent a respective one of said plurality of cable mounting recesses.

8. The fiber enclosure as set forth in claim 7, wherein each of said plurality of strain relief brackets comprises: (i) a strain relief clamp adapted to be secured to a strength member of one of the associated fiber optic cables; and (ii) first and second flanges that are respectively slidably engaged with the first and second bracket slots of the respective one of the said plurality of cable mounting recesses.

9. The fiber enclosure as set forth in claim 1, wherein:
the first and second compression plates each comprise a periphery and a plurality of cable pass-through recesses;
the first and second compression plates are aligned with each other so that the plurality of cable pass-through recesses are respectively registered with each other as between the first and second compression plates; and,
the plurality of cable pass-through recesses are each aligned with a respective one of the plurality of cable ports of the gel seal element.

10. The fiber enclosure as set forth in claim 9, wherein the cable pass-through recesses of each of the first and second compression plates are normally closed by a removable web that can be selectively broken away to open the cable pass-through recess through the periphery.

11. The fiber enclosure as set forth in claim 9, wherein the first and second compression plates each include a plurality of circumferentially spaced-apart axial tabs that extend axially inward toward the gel seal element and that are received in corresponding respective notches defined in the gel seal element.

12. The fiber enclosure as set forth in claim 11, wherein said gel seal element comprises:
a center core portion that is generally disc shaped;
an outer annular ring portion that surrounds the center core portion and that includes an axial split to allow the outer annular ring portion to be installed around the center core portion.

13. The fiber enclosure as set forth in claim 12, wherein the plurality of cable ports are partially defined in an outer peripheral surface of the center core portion and partially defined in the inner peripheral surface of the outer ring portion.

14. The fiber enclosure as set forth in claim 13, wherein the center core portion is radially split into a first center core portion and a second center core portion, wherein said first and second center core portions include respective inner core faces that are abutted with each other and include respective outer core faces that are oriented outwardly away from each other, wherein the respective inner core faces are softer than the respective outer core faces.

15. The fiber enclosure as set forth in claim 14, wherein the outer ring portion is radially split into a first ring portion and a second ring portion, wherein said first and second ring portions include respective inner ring faces and respective outer ring faces, and wherein the respective inner ring faces are abutted with each other and are relatively softer than the respective outer ring faces.

16. The fiber enclosure as set forth in claim 15, wherein the notches are defined in the outer ring faces of the gel seal element.

17. The fiber enclosure as set forth in claim 1, wherein said gel seal element comprises:
a center core portion that is generally disc shaped;
an outer annular ring portion that surrounds the center core portion and that includes an axial split to allow the outer annular ring portion to be installed around the center core portion.

18. The fiber enclosure as set forth in claim 17, wherein the plurality of cable ports are partially defined in an outer peripheral surface of the center core portion and partially defined in the inner peripheral surface of the outer ring portion.

19. The fiber enclosure as set forth in claim 18, wherein the center core portion is radially split into a first center core portion and a second center core portion, wherein said first and second center core portions include respective inner core faces that are abutted with each other and include respective outer core faces that are oriented outwardly away from each other, wherein the respective inner core faces are softer than the respective outer core faces.

20. The fiber enclosure as set forth in claim 19, wherein the outer ring portion is radially split into a first ring portion and a second ring portion, wherein said first and second ring portions include respective inner ring faces and respective outer ring faces, and wherein the respective inner ring faces are abutted with each other and are relatively softer than the respective outer ring faces.

21. A fiber enclosure comprising:
a lower portion including a base and an upper portion including a dome that is selectively secured to the base;
a fiber optic splice tray support structure located in an internal space of the dome;
a gel seal insert located in the base and including a gel seal element located between first and second compression plates, said gel seal insert including an actuator that is accessible outside the base and selectively actuatable to compress the gel seal element between the first and second compression plates, the gel seal element including a plurality of cable ports for passage of fiber optic cables through the base and into the internal space of the dome, wherein said gel seal element inhibits ingress of water and/or other environmental contaminants into the internal space of the dome between the cables and the gel seal element;
wherein:
the first and second compression plates each comprise a periphery and a plurality of cable pass-through recesses;
the first and second compression plates are aligned with each other so that the plurality of cable pass-through recesses are respectively registered with each other as between the first and second compression plates; and,
the plurality of cable pass-through recesses are each aligned with a respective one of the plurality of cable ports of the gel seal element;
the cable pass-through recesses of each of the first and second compression plates are normally closed by a removable web that can be selectively broken away to open the cable pass-through recess through the periphery.

22. The fiber enclosure as set forth in claim 21, wherein the first and second compression plates each include a plurality of circumferentially spaced-apart axial tabs that extend axially inward toward the gel seal element and that are received in corresponding respective notches defined in the gel seal element.
